(19) United States
(12) Patent Application Publication
(10) Pub. No.: US 2005/0267768 A1
(43) Pub. Date: Dec. 1, 2005

(54) Aircraft service system

(75) Inventor: Mark Edwin Seader, Fort Collins, CO (US)

Correspondence Address: CR MILES, P.C., 1 OLD TOWN SQUARE, SUITE 200 B, FORT COLLINS, CO, 80524, US

(73) Assignee: Innovaire, LLC

(21) Appl. No.: 10/854,102

(22) Filed: May 25, 2004

(51) Int. Cl. G06F 17/60

(52) U.S. Cl. 705/1

(57) ABSTRACT

An aircraft service system in which members obtain aircraft service through an aircraft service provider which coordinates aircraft service activities of a plurality of aircraft service agents in a plurality of aircraft service territories.

An aircraft service system in which members obtain aircraft service through an aircraft service provider which coordinates aircraft service activities of a plurality of aircraft service agents in a plurality of aircraft service territories.

### BACKGROUND

Unlike a disabled automobile having a location on the normally traveled road or thoroughfare readily accessible or ready to be towed to the nearest automobile service center, the nature of flying often places the aircraft requiring service at a location far from home, not safely reached from the normally traveled road, and not simply towed to the nearest aircraft service center.

Aircraft repair and maintenance facilities are relatively few in number, provide specialized service corresponding to certain mechanical or airframe components of the aircraft, and may be isolated from the actual location of the aircraft requiring service. As such, the aircraft owner may have no choice but to depend upon the knowledge and skill level of persons with which he has no familiarity to coordinate repair of the aircraft at a distant aircraft repair facility.

Additionally, because individual aircraft exhibit idiosyncratic characteristics determining what repair or service is required can be difficult especially for the aircraft facility which has not provided prior service for the aircraft. This compounds the problem of the aircraft owner because expensive preliminary service may be performed prior to making the aircraft repair.

Moreover, aircraft facilities unfamiliar with an aircraft must in serial fashion assess and diagnose the repair or service problem, locate a qualified technician to service the aircraft, locate aircraft components which can be purchased, purchase the components, wait for delivery of the aircraft components, and perform the aircraft repair or service. This approach to aircraft service can result in a lengthy delay in and increased costs for aircraft repair or service.

Because aircraft represent significant capital assets which are often purchased to facilitate business transactions the time needed to identify fixes for service problems and to complete the aircraft repair or service can negatively impact revenue of business which owns the aircraft.

The aircraft service system invention described below addresses each of the above-described problems.

### SUMMARY OF THE INVENTION

Accordingly, a broad object of the invention can be to provide an aircraft service provider that establishes the boundaries of a plurality of aircraft service territories and maintains a plurality of aircraft service agents in such aircraft service territories to service aircraft.

Another broad object of the invention can be determination by the aircraft service provider as to which of the plurality of aircraft service agents will service an aircraft having a location in one of the plurality of aircraft service territories.

Another broad object of the invention can be to provide a diagnostician within the aircraft service provider which can receive communications about aircraft characteristics and which can prepare an aircraft service profile describing necessary, recommended, or desirable aircraft service for an aircraft having a location in one of the plurality of aircraft service territories.

Another broad object of the invention can be to provide a service elements inventory within the service provider or establish inventory centers outside the service provider from which service elements can be obtained and transferred to the aircraft service agent selected to service an aircraft having a location within an aircraft service territory.

Another broad object of the invention can be to provide a logistician within the aircraft service provider to coordinate aircraft service which can include without limitation selection of the aircraft service agent to perform aircraft service, transfer of communications about aircraft characteristics to a diagnostician, obtain service elements, to transfer service elements to the location of the aircraft, transfer the aircraft service profile to the selected aircraft service agent, and assessing and recording expenditures of labor, materials or costs, or the like.

Another broad object of the invention can be to recruit members and provide aircraft service memberships in the aircraft service provider based upon meeting criteria for membership such as the type or kind of aircraft owned, the likelihood of having the aircraft located in one of the aircraft service territories for service, the ability to make periodic membership fees, or the like.

Naturally, further goals and objects of the invention are disclosed throughout other areas of the specification, drawings, photographs, and claims.

### BRIEF DESCRIPTION OF THE DRAWINGS

FIG. 1 provides a flow diagram which illustrates an embodiment of the aircraft service system invention.

### DETAILED DESCRIPTION OF THE PREFERRED EMBODIMENTS

An aircraft service system providing an aircraft service provider which establishes a plurality of aircraft service agents in a plurality of aircraft service territories to provide aircraft service to aircraft having a location in one of the plurality of aircraft territories.

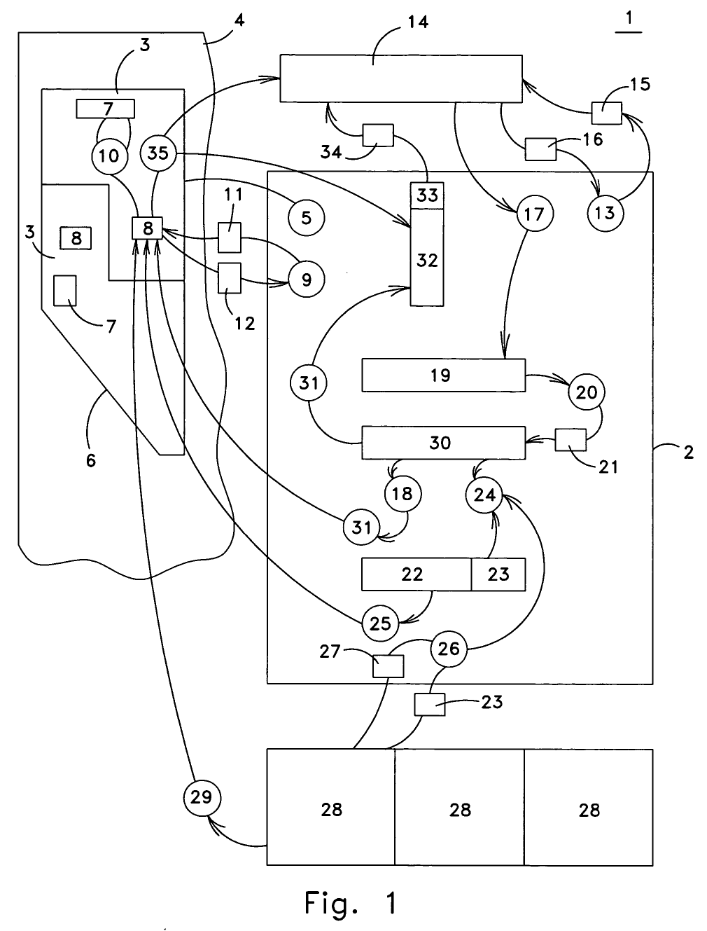

Now referring to FIG. 1, a generic embodiment of the aircraft service system (1) invention can include an aircraft service provider (2) which establishes (5) a plurality of aircraft service territories (3) in a geographic area (4). The aircraft service provider (2) can be an individual person or can be a business entity having a fixed or mobile business location. As a non-limiting example, an aircraft service provider can be a business entity having facilities at a single location in the United States which establishes (5) a plurality of aircraft service territories (3) within a geographic area (4) such as a state, a county, or the like. As a further non-limiting example, the aircraft service provider (2) can be a business entity having its facilities distributed throughout the United States which establishes (5) a plurality of aircraft service territories (3) within the United States.

The step of establishing (5) the plurality of aircraft service territories (3) by the aircraft service provider (2) can include the step of generating a boundary (6) for each of the plurality of aircraft service territories (3) based upon the analysis of a number of factors regarding the geographic area (4), including, but not limited to, the type or kind of aircraft (7) serviced at locations within the geographic area (4); the flight paths of aircraft within a geographic area; the incidence of aircraft service at locations within the geographic area (4); the type or kind of aircraft service performed at locations within the geographic area (4); the amount of revenue generated from such aircraft service; the availability of aircraft repair agents (8); the characteristics of the terrain within the geographic area (4); accessibility, travel conditions, and travel time in and to particular locations within the geographic area (4); existing or planned aircraft service infrastructure (such as regional or local airports or air fields, aircraft service centers, or the like within the geographic area (4)(not shown in figures); population within the geographic area (4); state, county and local jurisdiction boundaries within the geographic area (4); international, national, state, and local law; or the like.

As such, each one of the plurality of aircraft service territories (3) established (5) by the aircraft service provider (2) may encompass a different portion of the geographic area (4). As a non-limiting example, a particular one of the plurality of aircraft service territories (3) may encompass a relatively small geographic area which includes a regional airport, while another one of the plurality of aircraft service territories (3) may encompass a relatively large geographic area which has no aircraft service infrastructure. The established boundary (6) of a particular one of the aircraft service territories (3) may also be irregular in shape to include, as a further non-limiting example, a certain level of aircraft infrastructure such as an airfield and to exclude for example, and without limitation, ocean area not serviceable.

Also, different embodiments of the aircraft service system (1) invention may allow certain of the plurality of aircraft service territories (3) to overlap. As a non-limiting example, a first embodiment of the aircraft service system (1) may establish (5) a plurality of aircraft service territories (3) each having a boundary (6) established for the service of an aircraft (7) of a first type or kind, while a second embodiment of the aircraft service system (1) may establish (5) a plurality of aircraft service territories (3) each having a boundary (6) established for the service of an aircraft (7) of a second type or kind.

In any event, the boundary (6) of each one of the plurality of aircraft service territories (3) can be altered by the aircraft service provider (2) in response to variation in one or more of the factors set out above, or others as they arise, so that aircraft (7) to be serviced within a particular one of the plurality of aircraft service territories (3) can be serviced by at least one aircraft service agent (8).

Again referring to FIG. 1, embodiments of the aircraft service system (1) invention can further include a plurality of aircraft service agents (8) at least one each having an agency in a corresponding one or more of the plurality of aircraft service territories (5). The step of creating an agency (9) by the aircraft service provider (2) in each of the plurality of aircraft service territories (3) can involve an agreement or contract (11) which grants rights to be an agent (8) in one or more of the plurality of territories (3) in exchange for some type or kind of consideration (12). The step of creating the agency (9) can further include an assessment to qualify each of the plurality of aircraft service agents (8) based upon various factors including, but not limited to, the incidence of aircraft service within the particular one of the aircraft service territories (3), the types or kinds of aircraft serviced within the particular one of the plurality of aircraft service territories (3), the portion of the geographic area (4) encompassed by the particular one of the aircraft service territories (3), the type, kind, or level of experience required of the prospective aircraft service agent(s)(8) in a particular one of the plurality of aircraft service territories (3), the existing aircraft infrastructure in the particular one of the plurality of aircraft service territories, or the like.

As to certain embodiments of the aircraft service system (1) invention, more than one of the plurality of aircraft service agents (8) may have an agency (11) in a particular one of the aircraft service territories (3), while as to other embodiments of the aircraft service system (1) a single one of the plurality of aircraft service agents (8) can be shared between two or more of the plurality of aircraft service territories (3) with wages and benefits to the aircraft service agent paid pro-rata based upon the revenue generated in each of the plurality of aircraft service territories by the aircraft service agent, or paid based upon another formula or agreement between each of the plurality of aircraft service territories (3), or the aircraft service provider (2), and the aircraft service agent.

With respect to certain embodiments of the aircraft service system (1) invention, a particular one of the plurality of aircraft service agents (8) can be an individual person; however, importantly, as to other embodiments of the aircraft service system (1) invention, the aircraft service agent can be a business entity which can provide within a particular one of the plurality of aircraft service territories a composite of employees, equipment, and skill sets to provide aircraft service (10). In any event, each of the plurality of aircraft service territories (3) can include a sufficient number of aircraft service agents (8) whether individual persons or business entities in or shared between them to provide aircraft service (10) to those aircraft (7) within each of the plurality of aircraft service territories (3).

Again referring to FIG. 1, as to certain preferred embodiments of the aircraft service system (1), the aircraft service provider can take the further step of creating (13) aircraft service system memberships (15). In these certain preferred embodiments of the invention, an aircraft owner (14) which meets certain membership criteria can obtain an aircraft service system membership (15) in exchange for certain types or kinds of consideration (16). The membership criteria can include, but are not necessarily limited to, the type or kind of aircraft (7) owned by the aircraft owner (14), the geographic area (4) in which the aircraft is flown, the ability to make periodic payment of fees, or like. A membership (15) provides access to the aircraft service provider (2) to obtain aircraft repair services (10) for aircraft (7) having a location in one of the plurality of aircraft service territories (3) from the plurality of aircraft service agents (8).

Certain embodiments of the aircraft service system (1) further include the step of receiving aircraft service characteristics (17) by the aircraft service provider (2) from the aircraft owner (14) or other person authorized to provide such information by the aircraft owner (14), including, but not limited to, type and kind of aircraft (7), location of aircraft, type and kind of aircraft service required, aircraft symptoms observed, or other information. The aircraft service provider (2) can then utilize received aircraft service characteristics (17) in the step of determining (18) which of the plurality of aircraft service agents (8) to provide aircraft service (10) to the aircraft (7).

As to certain embodiments of the aircraft service system (1), the aircraft service provider (2) can further include a aircraft service diagnostician (19) which analyzes aircraft service characteristics received (17) to determine the type or kind of aircraft service (10) necessary or desirable under the circumstances. The diagnostician (19) can perform the step of preparing (20) an aircraft service profile (21) which can include a description of the recommended or necessary aircraft service (10) (whether service to the aircraft mechanical components, such as the engine, or to the airframe, or a component thereof) to be performed with respect to the aircraft (7) located in one of the plurality of aircraft territories (3) by one of the plurality of aircraft service agents (8).

The aircraft service profile (21) can provide a description of the aircraft service recommended or necessary and can further include a list of service elements (23) such as aircraft engine components, airframe components, landing gear components, electrical components, lubricants, paints, cleaners, windscreens, tires, batteries, preventative maintenance, tools, service instructions, or the like. As to certain embodiments of the aircraft service system (1) the aircraft service profile (21) can be used to match the type, kind, or level of skill which corresponds to the aircraft service (10) required, recommended, or necessary with the skill set(s) of particular aircraft service agents (8) in the aircraft service territory (3) in which the aircraft (7) is located. The aircraft service profile (21) can be forwarded (31) from the diagnostician (19) to one or more of the plurality of aircraft service agents (8) to assist in providing aircraft service (10).

In other embodiments of the aircraft repair service system (1), the aircraft service provider (2) can further include a service elements inventory (22) which comprises various types and kinds of service elements (23) such as mechanical and airframe components, parts, or other materials utilized in aircraft service (10). The aircraft service provider (2) can take further steps of obtaining (24) service elements from the service elements inventory (22) within the aircraft service provider (2) and the step of transferring (25) the service elements (23) to the location of the aircraft (7) or to one of the plurality of service agents (8) selected to provide aircraft service (10).

Alternately, or in combination with the service elements inventory (22), the aircraft service provider (2) can take the further step of establishing (26) one or more inventory center(s) (28)(whether within or without the geographic area (4)) outside of the aircraft service provider (2). As to certain embodiments of the aircraft service system (1), the aircraft service provider may have an agreement with each of the one or more inventory center(s)( to provide service elements (23) in exchange for a type or kind of service element consideration (27). The step of obtaining service elements (24) can then include obtaining service elements from the service elements inventory (22) or one or more of the inventory center(s)(28). The service elements (23) from one or more inventory center(s)(28) can be transferred (29) to one or more of the plurality of aircraft service agents (8) or to the location of the aircraft (7) to support aircraft service (10).

Certain embodiments of the aircraft service system (1) can further include a logistician (30) which coordinates one or more of the steps of determining (18) which of the plurality of aircraft service agents (8) to provide aircraft services (10), transferring (31) the aircraft service profile (21) to the selected (18) one of the plurality of aircraft service agents (8) selected, obtaining (24) service elements (23) from the service elements inventory (22), obtaining (24) service elements (23) from one or more of a plurality the inventory centers (28), transferring (25)(29) service elements (23) to the location of the aircraft (7) or to one or more of the plurality of aircraft service agents (8), or recording expenditures of labor, material, or costs (whether those expended by the aircraft service provider (2), inventory centers (28), or the plurality of aircraft service agents (8) in providing aircraft service (10).

Embodiments of the aircraft service system (1) invention can further include an accountant (32) (whether employed by or contracted by the aircraft service provider (2)) to provide the further step of (33) accounting for aircraft service expenditures (34). The step of accounting can culminate in the step of invoicing services (34) of the aircraft service provider (2) to the aircraft owner (14) for all aspects of aircraft service (10) which in part includes invoicing services (36) of the aircraft agent(8). Alternately, the step of invoicing services (36) of the aircraft agent can be separate from the step of invoicing services (35) of the aircraft service provider.

As can be easily understood from the foregoing, the basic concepts of the present invention may be embodied in a variety of ways. The invention involves numerous and varied embodiments of an aircraft service system (1) and methods of making and using the aircraft service system (1).

As such, the particular embodiments or elements or steps of the invention disclosed by the description or shown in the figure accompanying this application are not intended to be limiting, but rather exemplary of the numerous and varied embodiments of the aircraft service system generically encompassed by the invention or equivalents thereof. In addition, the specific description of a single embodiment or element of the invention may not explicitly describe all embodiments or elements possible; many alternatives are implicitly disclosed by the description and figure.

It should also be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of an “accountant” should be understood to encompass disclosure of the act of “accounting”—whether explicitly discussed or not—and, conversely, were there effectively disclosure of the act of “accounting”, such a disclosure should be understood to encompass disclosure of an “accountant” and even a “means for accounting”. Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the aircraft service systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below are intended describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A method of servicing an aircraft, comprising the steps of:
a. establishing a plurality of aircraft service territories;
b. maintaining a plurality of aircraft service agents in said plurality of aircraft service territories; and
c. establishing an aircraft service provider to determine which of said plurality of aircraft service agents to service an aircraft having a location in one said plurality of aircraft service territories.

2. A method of servicing an aircraft as described in claim 1, further comprising the step of sending aircraft characteristics about an aircraft having a location within a plurality of aircraft service territories to an aircraft repair provider.

3. A method of servicing an aircraft as described in claim 2, further comprising the step of establishing an aircraft service profile at the location of said aircraft service provider based upon said aircraft characteristics.

4. A method of servicing an aircraft as described in claim 3, further comprising the step of obtaining aircraft service material from the location of said aircraft provider based upon said aircraft service profile.

5. A method of servicing an aircraft as described in claim 4, further comprising the step of coordinating transfer of said aircraft service material to said aircraft having a location in one said plurality of aircraft service territories.

6. A method of servicing an aircraft as described in claim 1, further comprising the step of selecting which of said plurality of aircraft service agents established by said aircraft service provider within said plurality of aircraft service territories to service said aircraft having a location in one said plurality of aircraft service territories.

7. A method of servicing an aircraft as described in claim 6, further comprising the step of providing said service profile to a selected aircraft service agent.

8. A method of servicing an aircraft as described in claim 1, further comprising the step of sending said selected aircraft service agent to service said aircraft having a location within said plurality of aircraft service territories.

9. A method of servicing an aircraft as described in claim 1, further comprising the step of offering at least one membership with said aircraft repair provider which covers said aircraft having a location in said plurality of aircraft repair territories.

10. A method of servicing an aircraft as described in claim 9, further comprising the step of obtaining at least one member to receive said at least one membership with said aircraft service provider which covers said aircraft having a location in said plurality of aircraft service territories.

11. An aircraft service system in accordance with the method of claim 1.

12. An aircraft service system, comprising:
a. a plurality of aircraft service territories;
b. a plurality of aircraft service agents located in said plurality of aircraft service territories; and
c. an aircraft service provider having communication with said plurality of aircraft service agents, wherein said aircraft service provider determines which of said plurality of aircraft service agents to service an aircraft at a location in said plurality of aircraft service territories.

13. An aircraft service system as described in claim 12, further comprising aircraft characteristics about said aircraft having a location within said plurality of aircraft service territories sent to said aircraft service provider.

14. An aircraft service system as described in claim 13, further comprising an aircraft service profile generated by said aircraft service provider based upon said aircraft characteristics, wherein said aircraft service agent receives said aircraft service profile to assist in service of said aircraft at said location in said plurality of aircraft service territories.

15. An aircraft service system as described in claim 14, further comprising aircraft service material for said aircraft obtained by said aircraft service provider based upon said aircraft service profile, wherein said aircraft service provider coordinates transfer of said service material to said aircraft at said location in said plurality of aircraft service territories.

16. An aircraft service system as described in claim 15, further comprising a selected aircraft service agent from said plurality of aircraft service agents, wherein said aircraft service provider provides said aircraft service agent with said aircraft service profile.

17. An aircraft service system as described in claim 16, wherein said aircraft service provider sends said selected aircraft service agent to said aircraft at said location in said plurality of aircraft service territories to service said aircraft.

18. A method of servicing an aircraft, comprising the steps of:
a. sending aircraft characteristics about an aircraft having a location within a plurality of aircraft service territories to an aircraft service provider;
b. establishing a aircraft service profile at the location of said aircraft service provider based upon said aircraft characteristics;
c. selecting which of a plurality of aircraft service agents established by said aircraft service provider within said plurality of aircraft service territories to service said aircraft;
e. providing said aircraft service profile to a selected aircraft service agent; and
f. sending said selected aircraft service agent to service said aircraft having a location within said plurality of aircraft service territories.

19. An aircraft service system, comprising:
a. a plurality of aircraft service agents located in a plurality of aircraft service territories;
b. an aircraft service provider having communication with said plurality of service agents, wherein said aircraft service provider determines which of said plurality of aircraft service agents to service an aircraft at a location in said plurality of aircraft service territories; and
c. an aircraft service profile generated by said aircraft service provider based upon aircraft characteristics, wherein said aircraft service agent receives said aircraft service profile to assist in service of said aircraft at said location in said plurality of aircraft service territories.

20. An aircraft service system, comprising:
a. an aircraft service provider;
b. a plurality of aircraft service agents established in a plurality of territories by said aircraft service provider, wherein said aircraft service provider determines which of said plurality of aircraft service agents to service an aircraft having a location in said plurality of aircraft service territories;
c. at least one member having a membership in said aircraft service system which covers said aircraft having a location in said plurality of aircraft service territories.
